(19) United States
(12) Patent Application Publication
(10) Pub. No.: US 2024/0421373 A1
(43) Pub. Date: Dec. 19, 2024

(54) METHOD FOR OPENING AN ELECTROCHEMICAL GENERATOR

(71) Applicants: COMMISSARIAT À L'ÉNERGIE ATOMIQUE ET AUX ÉNERGIES ALTERNATIVES, Paris (FR); ORANO, CHATILLON (FR)

(72) Inventors: Emmanuel BILLY, Grenoble (FR); Hélène PORTHAULT, Grenoble (FR)

(21) Appl. No.: 18/701,786

(22) PCT Filed: Oct. 17, 2022
(86) PCT No.: PCT/FR2022/051956

§ 371 Date: Apr. 16, 2024

(30) Foreign Application Priority Data
Oct. 19, 2021 (FR) 2111071

(51) Int. Cl. H01M 10/54; H01M 10/44

(52) U.S. Cl. CPC H01M 10/54; H01M 10/44

(57) ABSTRACT

A method for opening an electrochemical generator comprising a negative electrode containing lithium or sodium and a positive electrode optionally containing lithium or sodium, the method including the following successive steps: a) immersing the electrochemical generator in a solution comprising an inert liquid and, optionally, a so-called oxidising redox species able to be reduced on the negative electrode so as to discharge the electrochemical generator, b) opening the electrochemical generator, in the solution, with a cutting element having an electrical resistance of between 1 mΩ and 1 kΩ, and preferably between 5 mΩ and 100Ω.

### TECHNICAL FIELD

The present invention relates to a method for opening an electrochemical generator, such as an accumulator, a cell or a battery, making it possible to open the electrochemical generator in complete safety and thus subsequently to recycle the recoverable fractions.

The invention is particularly advantageous for recycling electrochemical systems of the accumulator or cell type treated separately or in a mixture, and in particular for recycling batteries and accumulators of the Li-ion, Na-ion or lithium-metal type.

### PRIOR ART

An electrochemical generator is an electricity-producing device converting chemical energy into electrical energy. Examples include cells or accumulators. The accumulator market, and in particular for lithium accumulators of the Li-ion type, is strongly expanding at the present time, firstly because of so-called roaming applications (smartphone, computer, photographic apparatus, etc.) and secondly because of new applications related to mobility (electric and hybrid vehicles) and to so-called stationary applications (connected to the electricity network).

Because of the growth in the number of accumulators over the past years, the question of recycling them has therefore become a major challenge.

Conventionally, a lithium-ion accumulator comprises an anode, a cathode, a separator, an electrolyte and a casing.

Generally, the anode is formed from graphite mixed with a binder of the PVDF type deposited on a sheet of copper and the cathode is a metallic lithium insertion material (for example LiCoO₂, LiMnO₂, LiNiO₂, LiNixCo₁₋ₓO₂ with 0<x<1, Li₃NiMnCoO₆, or LiFePO₄) mixed with a binder and deposited on a sheet of aluminium.

The electrolyte is a mixture of non-aqueous solvents and lithium salts, and optionally additives for slowing secondary reactions.

The operation is as follows: during charging, the lithium deintercalates from the metallic oxide and intercalates in the graphite, where it is thermodynamically unstable. During discharging, the process is reversed and the lithium ions are intercalated in the metallic lithium oxide.

As it is used, ageing causes a loss of capacity and the accumulator must be recycled.

Conventionally, the method for recycling accumulators comprises several steps:
a pre-treatment step including a dismantling phase and a making-safe phase,
heat and/or hydrometallurgical treatments for recovering the various recoverable materials and metals contained in these cells and accumulators.

However, several situations may complicate recycling:
a large number of accumulators or of batteries of accumulators to be recycled may still be at least partially charged and grinding them produces sparks and significant ignitions or even explosions, in particular with primary lithium (Li—SOCl₂) cells,
damaged cells may be damaged and for example have deposits of metallic lithium on the anode which, exposed to air or to water, are very reactive.

Electrochemical systems, at the end of life and/or damaged, to be recycled must therefore be treated with the utmost precaution.

At the present time, the main problem therefore lies in the phase of making safe and of opening these lithium-based electrochemical systems (primary and secondary).

This is because, when there is a loss of confinement, leakages of electrolyte occur, a toxic, flammable and corrosive product, in liquid form but also gaseous. The vapours thus generated and mixed with air can then form an explosive atmosphere (EXAT). This is liable to ignite in contact with an ignition source of the spark type or a hot surface. The result is then an explosion causing thermal effects and pressure effects. In addition, electrolyte salts such as lithium hexafluorophosphate LiPF₆, lithium tetrafluoborate LiBF₄, lithium perchlorate LiClO₄ and lithium hexafluoroarsenate LiAsF₆ can give off particularly toxic and corrosive fumes containing phosphorus, fluorine and/or lithium. For example, there may be the formation of hydrofluoric acid (HF) during the thermal degradation of Li-ion batteries.

To remedy these drawbacks, it is possible to grind the batteries in an enclosure under controlled atmosphere and pressure. By way of example, the document WO 2005/101564 A1 describes a method for recycling a lithium-anode battery hydrometallurgically, at ambient temperature and under inert atmosphere. During grinding, the atmosphere comprises argon and/or carbon dioxide. The two gases will drive out the oxygen and form a gaseous protective ceiling above the ground load. The presence of carbon dioxide will lead to initiating a passivation of the metallic lithium by forming lithium carbonate on the surface, which slows down the reactivity of this metal. Hydrolysis of the ground load containing lithium leads to the formation of hydrogen. To avoid the risks of ignition of the hydrogen and of explosion, the ground load containing the lithium is added to the aqueous solution in a highly controlled manner and a very strong turbulence above the bath is created. This operation is associated with an oxygen-depletion of the atmosphere. The water becomes rich in lithium hydroxide and the lithium is recovered by adding sodium carbonate or phosphoric acid.

In the method of the U.S. Pat. No. 5,888,463 A, the cells and accumulators are made safe by a cryogenic method. The cells and accumulators are frozen in liquid nitrogen at −196° C. before being ground. The ground material is next immersed in water. To avoid the formation of H₂S, the pH is maintained at a pH of at least 10 by adding LiOH. The lithium salts formed (Li₂SO₄, LiCl) are precipitated in the form of carbonate formed by adding sodium carbonate. Such a method is particularly expensive.

The document CA 2 313 173 A1 describes a method for recycling lithium ion cells. The cells are previously cut in an inert atmosphere devoid of water. A first organic solvent (acetonitrile) dissolves the electrolyte and a second organic solvent (NMP) dissolves the binder. The particulate insertion material is next separated from the solution and reduced by electrolysis.

In the document JP2010198865 A, a rotary insulating cutting tool is used to remove the active core from the casing of the cell. This method requires thorough knowledge of the cells and precise positioning of each unitary cell with respect to the cutting blade, which cannot be envisaged in the context of industrial processing with high work rates.

In the document WO 2011/113860 A1, a so-called dry method (“dry technology”) is described. This mechanical method is based on a two-stage crushing line followed by a magnetic and mechanical separation unit and on good management of the ventilation. The method does not require any pre-treatment step for discharging the Li-ion batteries. The batteries are crushed (or chopped) by a toothed or bladed apparatus, for example made from steel. The temperature of the grinder is maintained at between 4° and 50° C. and the mixture of hydrogen and oxygen released from the batteries is eliminated, by a cyclonic air movement, to minimise the risks of initiation of fire. The pieces of battery and dust, recovered after sieving, are cooled to ambient temperature. Extraction of the lithium appears to be done by reaction with the oxygen and humidity of the air, causing risks related to the simultaneous presence of hydrogen, oxygen and heat propitious to combustion and explosion. However, this method has several drawbacks:
grinding these accumulators causes crushing and short-circuits that may cause an explosion,
the electrolyte is degraded, causing risks, losses and difficulties with respect to management of the dust and gases,
this approach does not enable the batteries to be made safe without risk,
maintaining the temperature of the grinder at between 4° and 50° C. is possible only with limited work rates not compatible with the flows of materials expected in future years, in particular coming from the electric-vehicle market.

The document EP 0 613 198 A1 describes a method for recovering materials coming from lithium cells. The cells are cut either under high-pressure water jet or in an inert atmosphere to avoid initiation of fire. Then the lithium reacts with water, an alcohol or an acid to form lithium hydroxide, a lithium alkoxide or a lithium salt (LiCl for example), respectively. However, making safe with cutting under high-pressure water jet requires high consumption of water and generates H₂ gases in air.

At the present time, the various methods for opening cells/batteries described above require implementing treatments at high temperature, cryogenic treatments, and/or treatments under controlled atmosphere, which are conditions that are difficult to achieve on an industrial scale and/or are expensive.

### DESCRIPTION OF THE INVENTION

One aim of the present invention is to propose a method for remedying the drawbacks of the prior art, and in particular a method for opening an electrochemical generator in complete safety, the method having to be easily implemented on an industrial scale and therefore compatible with high work rates.

This aim is achieved by a method for opening an electrochemical generator comprising a negative electrode containing lithium or sodium and a positive electrode, optionally containing lithium or sodium, the method comprising the following successive steps:
a) immersing the electrochemical generator in a solution comprising an inert liquid and, optionally, a so-called oxidising redox species able to be reduced on the negative electrode so as to discharge the electrochemical generator,
b) opening the electrochemical generator, completely or partially, with a cutting element having an electrical resistance of between 1 mΩ and 1 kΩ, and preferably between 5 mΩ and 100Ω, the opening being implemented in the solution.

The invention is fundamentally distinguished from the prior art firstly through the controlled opening of the electrochemical generator (cell or accumulator) in a non-reactive liquid medium, and secondly through the use of a particular cutting tool. The latter is designed to have a defined electrical resistance allowing a controlled discharge of the system in the inlet liquid. The cutting tool makes it possible both to cut a battery and simultaneously to act on the state of charge of this battery.

According to one embodiment of the method, the cutting element is maintained in contact with the electrochemical generator after said generator is opened in order to favour electrical discharge, in particular when the solution does not contain a so-called oxidising redox species.

The inert liquid can be deionised water, an ionic liquid or a deep eutectic solvent (DES).

Deionised water has for example a resistivity of between 18 MΩ and 20 MΩ.

The cation of the ionic liquid is for example selected from the family: imidazolium, pyrrolidinium, ammonium, piperidinium and phosphonium. Preferably, it is a case of a cation with a large cationic window, sufficiently great to envisage a cathodic reaction avoiding or minimising degradation of the ionic liquid, such as the imidazolium cation.

The cation is associated with an anion that will be indifferently organic or inorganic, preferentially having a large ionic window. Advantageously, use will be made of anions making it possible to obtain simultaneously a wide electrochemical window, moderate viscosity, a low melting point (liquid at ambient temperature) and a good solubility with the other species of the solution and not leading to hydrolysis (degradation) of the ionic liquid.

The TFSI anion is an example that meets the above-mentioned criteria. The ionic liquid will advantageously be selected from [BMIM] [TFSI], [P66614] [TFSI], the ionic liquid 1-ethyl-2,3-trimethyleneimidazolium bis(trifluoromethane sulfonyl)imide ([ETMIm] [TFSI]), the ionic liquid N,N-diethyl-N-methyl-N-2-methoxyethyl ammonium bis(trifluoromethylsulfonyl) amide [DEME] [TFSA], the ionic liquid N-methyl-N-butylpyrrolidinium bis(trifluoromethylsulfonyl) imide ([PYR14] [TFSI]), or the ionic liquid N-methyl-N-propylpiperidinium bis(trifluoromethanesulfonyl) imide ([PP13] [TFSI]).

The anion can also be of the type bis(fluorosulfonyl) imide (FSA or FSI). The ionic liquid with such an anion is for example the ionic liquid N-methyl-N-propylpyrrolidinium FSI ([P13] [FSI]), N-methyl-N-propylpiperidinium FSI ([PP13] [FSI]), 1-ethyl-3-methylimidazolium FSI ([EMI] [FSI]), etc.

The deep eutectic solvent (DES) is for example formed from choline chloride and a hydrogen-bond donor, such as a glycol (for example ethylene glycol or glycerol) or urea, in order to obtain a non-toxic DES at very low cost.

The inert solution may comprise one or more inert liquids. The inert liquids may have one or more of the following properties: non-volatile and non-flammable, chemically stable at temperatures that may be above 200° C. (for example between 200° C. and 400° C.) and/or with a large electrochemical stability window.

Using an inert liquid enables the cutting element to be introduced into the core of the active material of the electrochemical generator to ensure discharge thereof during opening, while avoiding a violent reaction with the water and/or air, and also makes it possible to evacuate the calories during the discharge process and favours cooling of the medium. The inert liquid makes opening the electrochemical generator safe.

The cutting element has intrinsic electrical resistance, so as to avoid an electrical short-circuit that would risk causing an excessively abrupt discharge between the positive and negative elements of the electrochemical generator. It affords control of the rate of discharge so that the temperature does not exceed the runaway limit as from which the cell would risk exploding. The resistances selected for the cutting element are dependent on the objects to be treated and on the discharge regimes that they can withstand. The use of such a cutting element according to the invention simultaneously allows the opening and discharge of the objects treated and guarantees that they are made safe.

The method simultaneously leads to the opening of the electrochemical generator in the inert liquid medium and to its making safe through deactivation of the electrical capacitance of the object.

The present invention relates to a method for securing batteries and all electrochemical systems of the accumulator or cell type, processed separately or as a mixture, whether they are still functional or have failed.

Preferably, the solution comprises a redox species capable of reacting with the lithium or sodium of the negative electrode (anode). Opening the electrochemical generator allows access to the electrodes: the redox species also carries out a discharge action by oxidation-reduction with the electrodes containing lithium (or sodium). This reactive species thus contributes to the discharge of the electrochemical generator during opening, which further avoids the risks of ignition and/or explosion.

According to the invention, the redox species is also able to be reduced on the negative electrode, i.e. the redox species can react either directly on the negative electrode (anode), in the case where the casing of the accumulator is open, or on another element electrically connected to the anode, such as the anodic current collector, the terminal of the anode or ground when the anode is electrically connected to ground. Hereinafter, when lithium is described, the lithium can be replaced by sodium.

For example, in the case of a lithium-metal accumulator, the reduction reaction of the so-called oxidising redox species leads to oxidation of the metallic lithium in ionic form.

According to another example, in the case of a lithium-ion accumulator, the reduction reaction of the so-called oxidising redox species leads to disinsertion of the lithium ion of the active material of the negative electrode.

The free ions extracted from the anode migrate through the ion-conducting electrolyte and are immobilised in the cathode, where they form a thermodynamically stable lithium oxide. Thermodynamically stable means that the oxide does not react violently with water and/or air.

Advantageously, the solution comprises a second so-called reducing redox species able to be oxidised on the positive electrode, the so-called oxidising redox species and the so-called reducing redox species forming a redox species pair.

Redox pair, also called redox mediator or electrochemical shuttle, means an oxidant/reducer (Ox/Red) pair in solution where the oxidant can be reduced on the anode (negative electrode) and the reducer can be oxidised on the cathode (positive electrode). The oxidation of the reducer and the reduction of the oxidant make it possible to form new oxidant/reducer species and/or to regenerate the species initially present in solution. The method is economical since the redox pair in solution simultaneously provides both the redox reactions at the electrodes/terminals of the electrochemical generator, so that the consumption of reagent is zero; the solution can be used to open several electrochemical generators successively and/or in a mixture.

The redox species also make it possible to discharge the electrochemical generator. In addition, when the electrochemical generator is opened, they will react with the internal components, so as to reduce the potential difference between the electrodes (anode and cathode). This internal discharge also contributes to the safety of the electrochemical generator by reducing the chemical energy of the electrodes (and therefore the potential difference) and by reducing the internal short-circuit effect.

Advantageously, the redox species pair is a metal pair, preferably selected from Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺, a pair of organic molecules, a pair of metallocenes such as Fc/Fc⁺, or a pair of halogenated molecules such as for example Cl₂/Cl⁻ or Cl⁻/Cl₃⁻.

According to a first advantageous variant, the electrochemical generator is opened (step b)) in air.

According to a second advantageous variant, the electrochemical generator is opened (step b)) in an inert atmosphere allowing control of the oxygen content. Thus the assembly is made safe (with respect to the fire triangle).

The method is not a thermal method and makes it possible to manage the step of opening the electrochemical accumulator. It can advantageously be implemented at ambient temperature (typically between 2° and 25° C.).

The ionic liquid solution can optionally be stirred and/or cooled. It is also possible to add to the solution species with advantageous calorific capabilities favouring cooling.

When the electrochemical generator is opened, the cutting element penetrates the electrochemical generator.

The cutting element comprises a support covered with abrasive zones, preferably electrically insulating.

The abrasive zones may, for example, be formed by grains.

The abrasive zones may, for example, be made from silicate.

The support is, for example, made from ceramic, from resin, from rubber, or from metal.

According to a particularly advantageous embodiment, the cutting element comprises a support covered both by abrasive zones and by electrically conductive zones.

The electrically conductive zones are, for example, formed by electrically conductive grains.

The abrasive zones and/or the electrically conductive zones may be disposed randomly or regularly on the support.

The abrasive zones and/or the electrically conductive zones may be secured to the support by a binder.

The cutting element used for opening the electrochemical generator may be a blade, for example a blade of the guillotine type, a circular or band blade, cutting wires, knives, or a grinding wheel.

Advantageously, the electrochemical generator is opened with a grinding wheel or a cutting wire.

Advantageously, the grinding wheel includes a support disc covered with abrasive zones and electrically conductive zones, disposed randomly or regularly, the abrasive zones and the electrically conductive zones being associated with the support by a binder. Preferably, the abrasive zones are formed by abrasive grains and/or the electrically conductive zones are formed by electrically conductive grains.

The cutting element may form part of a tool. Tool means a tool that can pierce, grind and/or cut. Technologies will be favoured that do not lead to excessively great deformation (crushing) in order to avoid short-circuits. Non-exhaustively, the opening can be implemented by cutting, sawing or abrasion. Preferably, the tool makes it possible to cut the electrochemical generator partially or totally.

Advantageously, the method comprises, prior to step a), a dismantling step and/or a sorting step.

Advantageously, the method comprises, subsequently to step b), a storage step and/or a pyrometallurgical and/or hydrometallurgical step.

The opening method according to the invention has numerous advantages:
the method makes it possible to implement two operations in a single step (making safe and opening the cells), which allows an increase in work rates and a significant saving in time and equipment: the work rate of the method is compatible with the high flows of material expected in future years;
the method, via the opening of the electrochemical generator, allows direct access to the active materials ensuring much more rapid discharge (no connection of the cells, no particular electrical equipment, etc.);
controlling the electrical resistance of the cutting element makes it possible to finely control the rate of discharge of the electrochemical generators, avoiding the runaway phenomena encountered when a short-circuit is created;
the method makes it possible to process all materials (modules, cells, etc.) that may arrive at recycling, in the discharged state or not (cells damaged for example because of mechanical degradation, degraded terminals (corrosion, etc.), having internal safety members triggered, etc.), since it is not based on the use of the terminals of the cells to achieve discharge;
the discharge of the electrochemical generator is controlled so as to minimise the risks of temperature rise leading to thermal runaway;
implementing the opening step in an inert liquid, thus avoiding a violent reaction with water and/air, reduces the problems related to the management of hydrogen, of oxygen and of heat, and therefore to the management of explosive atmosphere (safety, treatment of effluents, additional economic cost);
not using heat treatment makes it possible to limit problems related to the emission of gases (for example greenhouse gases or for any other harmful gas hazardous for humans and the environment) and to the treatment thereof, which reduces the financial and energy costs of the method;
being safe and simple to implement;
the method is implemented at low environmental and economic cost;
the treatment is not detrimental with respect to subsequent recycling of the components (degradation of the electrolyte, etc.);
the method enables the cells to be secured and opened to give access to the material of interest for recycling by pyrometallurgical and/or hydrometallurgical means.

In addition, in the case where the solution comprises a chemical species providing the extraction of lithium (or of sodium), the method also has the following advantages:
improving the making safe of the electrochemical generator by facilitating discharge thereof; such coupling provides a saving in time and a saving on a significant amount of investment;
being able to use a wide choice of active species, the active species simply having to have a redox potential higher than that of lithium (lithium is the species with the most negative standard redox potential and can therefore be extracted (oxidised) with any species capable of being reduced to a potential greater than −3.05 V vs. ENH).

The invention also relates to a cutting element as described previously, for opening an electrochemical generator.

The cutting element has an electrical resistance of between 1 mΩ and 1 kΩ, and preferably between 5 mΩ and 100Ω.

Advantageously, the cutting element comprises a support covered by abrasive zones (for example abrasive grains) and electrically conductive zones (for example electrically conductive grains or wires), the abrasive zones and the electrically conductive zones being disposed randomly or regularly and being associated with the support by a binder.

Advantageously, the cutting element is a cutting wire, a wheel of a grinding machine, a circular saw blade (also called a disc) or a saw band.

Invention also relates to a cutting tool comprising such a cutting element. The cutting tool is advantageously a grinding machine or a saw, for example a circular saw or a band saw.

Other features and advantages of the invention will emerge from the remainder of the following description.

It goes without saying that this additional description is given only by way of illustration of the object of the invention and must under no circumstances be interpreted as a limitation to this object.

### BRIEF DESCRIPTION OF THE DRAWINGS

The present invention will be best understood from the reading of the description of example embodiments given purely by way of indication and in no way limitatively, referring to the accompanying drawings, on which:

FIG. 1 shows, schematically an abrasive wheel composition according to a particular embodiment of the invention,

FIGS. 2A, 2B, 2C, 2D and 2E show, schematically and in cross section, abrasive wheels having various distributions of conductive zones and insulating zones, according to various embodiments of the method according to the invention.

FIG. 3A is a photograph of a 18650 cell after opening and discharge, according to a particular embodiment of the invention.

FIG. 3B is an image obtained by scanning electron microscope of the cross section of the cell of FIG. 3A.

FIG. 4 is a graph showing curves monitoring voltage and temperature as a function of time, when an Li-ion cell is opened, according to a particular embodiment of the invention.

The various parts shown on the figures are not necessarily shown to a uniform scale, to make the figures more legible.

### DETAILED DESCRIPTION OF PARTICULAR EMBODIMENTS

Hereinafter, even if the description refers to an Li-ion accumulator, the invention can be transposed to any electrochemical generator, for example to a battery comprising several accumulators (also referred to as batteries of accumulators), connected in series or in parallel, according to the nominal operating voltage and/or the quantity of energy to be supplied, or to an electric cell.

The opening method relates to all electrochemical systems of the accumulator, battery or cell type treated separately or as a mixture. For example, these could be electrochemical systems coming from portable devices, or cells or modules coming from the automotive industry that have higher power ratings and greater reactivity, making their processing more complex in terms of safety.

These various electrochemical devices may be of the metal-ion type, for example lithium-ion or sodium-ion, or of the Li-metal type, etc.

It may also be a primary system such as Li/MnO₂, or a redox flow battery.

An electrochemical generator having a potential greater than 1.5 V will advantageously be selected.

The method for opening the electrochemical generator comprises the following steps:
immersing the electrochemical generator in a solution comprising an inert liquid and, preferably, a redox species able to react with the lithium so as to neutralise it, then,
opening the electrochemical generator by a cutting element 100, the opening being implemented when the electrochemical generator is immersed in the solution.

The solution comprises at least one inert liquid. It may also contain a mixture of several inert liquids.

The inert liquid according to the invention is characterised by a good thermal stability, in particular in the temperature range between 10° C. and 150° C., and by a good electrochemical stability limiting the effects of degradation of the medium during contact with the cells, mainly at high potentials, and during discharging.

The inert liquid can be deionised water, an ionic liquid or a deep eutectic solvent (DES). It can also be a case of one of the mixtures thereof.

Deionised water (or demineralised water) has, for example, a resistance of 15 MΩ to 21 MΩ, preferably of 18 MΩ to 20 MΩ.

Ionic liquid means the association of at least one cation and of at least one anion that generates a liquid with a melting point below or close to 100° C. Examples include molten salts. The ionic liquid is stable on a thermal and electrochemical level, minimising an effect of degradation of the medium during the discharge phenomenon.

The cation is preferably selected from the family: imidazolium, pyrrolidinium, ammonium, piperidinium and phosphonium.

The anion is, for example, the TFSI or bis(fluorosulfonyl) imide (FSA or FSI) anion.

Advantageously, the ionic liquid will be selected from 1-butyl-3-methylimidazolium bis(trifluoromethane sulfonyl)imide [BMIM] [TFSI], trihexyl(tetradecyl) phosphonium bis(trifluoromethane sulfonyl)imide [P66614] [TFSI], 1-ethyl-2,3-trimethyleneimidazolium bis(trifluoromethane sulfonyl)imide ([ETMIm] [TFSI]), N,N-diethyl-N-methyl-N-2-methoxyethyl ammonium bis(trifluoromethylsulfonyl) amide [DEME] [TFSA], N-methyl-N-butylpyrrolidinium bis(trifluoromethylsufonyl) imide ([PYR14] [TFSI]), N-methyl-N-propylpiperidinium bis(trifluoromethanesulfonyl) imide ([PP13] [TFSI]), N-methyl-N-propylpyrrolidinium FSI ([P13] [FSI]), N-methyl-N-propylpiperidinium FSI ([PP13] [FSI]), and 1-ethyl-3-methylimidazolium FSI ([EMI] [FSI]).

DESs have the advantage of being non-toxic, biodegradable and of low cost. For example, choline chloride used with an H-bond donor with very low toxicity such as a glycol (glycerol or ethylene glycol for example) or urea, will be selected, in order to obtain a non-toxic DES at very low cost. Such solutions have a limited electrochemical stability window, but will make it possible to guarantee immersion and deactivation of an open accumulator. Proportions of components close to the eutectic points can also advantageously be selected in order to optimise the properties of the fluid, such as its conductivity or its viscosity. Thus varied molar mixtures of these components will be able to be envisaged.

By way of example, this could be a mixture of choline chloride and ethylene glycol in molar proportions ranging from 1:1 to 1:5.

Alternatively, choline chloride can be replaced by betaine.

The solution may furthermore comprise other components/agents to impart particular properties to the solution. For example, the solution may comprise electrochemical shuttles or flame retarders.

The electrochemical shuttle (also called redox mediator) can be added to reduce the degradation of the medium by ensuring the redox reactions. Redox mediator means an ion or species in solution capable of being reduced and oxidised on the terminals of the accumulators or cells. The mediator may be a metallic electrochemical pair selected for example from: Mn²⁺/Mn³⁺, Co^{2+/}Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺. The solution may also contain several metallic electrochemical pairs.

Alternatively, the redox mediator may be an organic species such as: 2,4,6-tri-t-butylphenoxyl, nitronyl nitroxide/2,2,6,6-tetramethyl-1-piperidinyloxy (TEMPO). tetracyanoethylene, tetramethylphenylenedi-amine, dihydrophenazine, aromatic molecules such as methoxy, the N,N-dimethylamino group (anisole methoxybenzene, dimethoxybenzene, and N,N-dimethylaniline N,N-dimethylaminobenzene). Mention can also be made of 10-methyl-phenothiazine (MPT), 2,5-di-tert-butyl-1,4-dimethoxybenzene (DDB) and 2-(pentafluorophenyl)-tetrafluoro-1,3,2-benzodioxaborole (PFPTFBDB).

The redox mediator may be from the family of metallocenes (Fc/Fc+, Fe(bpy)₃(ClO₄)₂ and Fe(phen)₃(ClO₄)₂ and the derivatives thereof) or from the family of halogenated molecules (Cl₂/Cl⁻, Cl⁻/Cl³⁻ Br₂/Br⁻, I₂/I⁻, I/I3), or it may be tetramethylphenylenediamine.

Preferably, Fe²⁺/Fe³⁺ and/or Cu⁺/Cu²⁺ will be used. The latter are soluble in their two oxidation states, they are not toxic, they do not degrade the inert liquid and they have suitable redox potentials for extracting lithium in the case of opening the accumulator. Alternatively, it is advantageous to use to redox pairs such as the combination V²⁺/V³⁺ and V⁴⁺/V⁵⁺.

The solution may include one or more so-called “active” species, for example an extinction agent and/or a flame retarder aimed at preventing thermal runaway, in particular during the opening of the accumulator. This may be an + alkyl phosphate, optionally fluorinated (fluorinated alkyl phosphate), such as trimethyl phosphate, triethyl phosphate, or tris(2,2,2-trifluoroethyl)phosphate). The concentration of active species may be between 5% and 80% by mass, preferably between 30% and 10% by mass.

Optionally, the solution may comprise a desiccating agent, and/or an agent favouring the transport of material, and/or a protective agent that is a stabiliser/reducer of corrosive and toxic species such as for example PF₅, HF, POF₃ etc.

The agent favouring the transport of material is, for example, a fraction of a co-solvent added for reducing the viscosity of the medium.

Preferably, an organic solvent will be selected for acting effectively without generating risks with regard to discharging or flammability. It may be a case of vinylidene carbonate (VC), gamma-butyrolactone (γ-BL), propylene carbonate (PC), polyethylene glycol or dimethyl ether. The concentration of the agent favouring the transport of material ranges, advantageously, from 1% to 40% and more advantageously from 10% to 40% by mass.

The protective agent suitable for reducing and/or stabilising the corrosive and/or toxic elements is, for example, a compound of the butylamine type, a carbodiimide (type N,N-dicyclohexylcarbodiimide), N,N-diethylamino trimethyl-silane, tris(2,2,2-trifluoroethyl)phosphite (TTFP), a compound based on amine such as 1-methyl-2-pyrrolidinone, a fluorinated carbamate or hexamethyl-phosphoramide. This may also be a compound in the cyclophosphazene family such as hexamethoxycyclotriphosphazene.

The cutting operation, implemented in the presence of the inert liquid, avoids a violent reaction with water and/or air. The inert liquid makes the opening of the cell/accumulator safe and, when the cutting tool is introduced into the active core of the material, enables the cell/accumulator to be discharged during opening. Finally, the inert liquid favours cooling of the medium and makes it possible to evacuate the calories during the discharge process.

The inert liquid contributes to the maintenance of a controlled atmosphere (air, water) and to the discharge in an advantageous manner, and fulfils the role of cutting fluid (lubrication and cooling of the cutting zone).

The cutting element 100 is sufficiently electrically conductive to allow the discharging operation and is sufficiently resistive to avoid a solid short-circuit leading to an explosion of the cell. In other words, the cutting element 100 has very low electrical conductivity. The electrical conductivity of the cutting element will be a mean conductivity seen by the sample to be cut, which will be dependent on the proportion of insulating zones and conductive zones, on the speed of rotation, on the speed of advance of the grinding wheel, etc.

The electrical resistance of the cutting element is adapted to this method of opening an electrochemical generator and is between 1 mΩ and 1 kΩ, and preferably between 5 mΩ and 100Ω. Thus a leakage current is generated at the cutting and makes it possible to control the discharge. The resistance is the mean resistance of the cutting element. At least the part of the cutting element intended to penetrate the sample for cutting it has such resistance. The resistance can be measured with a multimeter by putting a sample between two identical conductive plates.

The technologies to be favoured for implementing this opening are technologies that limit deformation (crushing, spreading of the materials over the adjacent materials, etc.), which would lead to a solid uncontrolled short-circuit leading to thermal runaway and explosion of the cells.

The cutting element 100 forms part of a cutting tool.

Cutting tool means a tool that can serve to grind and preferentially to cut the material in order to partially or completely open the electrochemical generator in an inert medium. Non-exhaustively, the cutting may be a cutting of the guillotine type (blades), a sawing operation (circular, with bands), by piercing and, preferentially, an abrasion method of the wire cutting type or by means of an abrasive wheel.

The cutting element 100 comprises a base support 101 conferring the mechanical properties on the cutting element 100.

The base support 101 can be electrically conductive or electrically insulating. The base support 101 can be metallic, resinoid or of the rubber type.

The base support 101 is covered by abrasive zones 102. The abrasive zones 102 have a hardness adapted to the object and material to be treated.

The abrasive zones 102 are, for example, made from sandstone, emery, diamond, silicon carbide and/or alumina.

Preferably, the abrasive zones are formed by abrasive grains.

Preferably, the base support 101 is covered by abrasive zones 102 and electrically conductive zones 103. The abrasive zones 102 confer the mechanical properties on the tool and electrically conductive zones 103 confer the electrical properties on the tool.

The electrically conductive zones 103 are, for example, formed by electrically conductive grains.

The electrically conductive zones 103 are, for example, made from a metal or metal alloy. By way of illustration, it may be a case of copper, iron, steel and/or aluminium, more broadly an electrical conductor.

The electrically conductive zones 103 may be formed by metallic grains 103 or metallic wires.

The abrasive grains and/or the electrically conductive grains are preferably particles having a dimension ranging for example from a few micrometres to a few centimetres.

The abrasive grains 102 and/or the electrically conductive grains 103 are advantageously held mechanically on the support 101 by a binder 104 (FIG. 1). The binder may be a resin, rubber, silicate, clay or a ceramic.

The abrasive zones 102 and/or the electrically conductive zones 103 may be disposed randomly or regularly on the support 101.

The abrasive zones 102 and/or the electrically conductive zones 103 may be continuous or discontinuous.

According to a first advantageous variant, the electrochemical generator is opened by abrasion by means of a wire 100. The wire 100 comprises a solid base 101, filiform in shape, conferring the mechanical properties. The abrasive properties are conferred by adding abrasive grains 102 with hardness adapted to the object and material to be treated.

According to a second variant embodiment, the electrochemical generator is opened by abrasion by means of a grinding machine. The disc of the grinding machine comprises a circular base support 101. The support comprises a first principal face and a second principal face parallel to each other and a lateral face (also called an edge) connecting the two principal faces.

The support 101 can be metallic, resinoid or of the rubber type. The support 101 is advantageously covered by electrically insulating abrasive zones 102 and by electrically conductive zones 103.

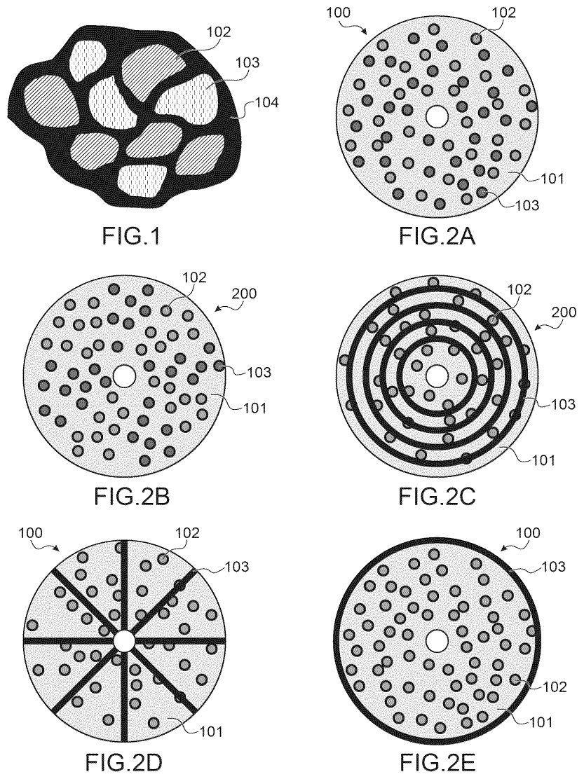

By way of illustration, as shown on FIGS. 2A to 2E, various configurations can be envisaged in the case of a grinding wheel comprising abrasive zones 102 (preferably abrasive grains) and electrically conductive zones 103 (preferably electrically conductive wires or grains).

The abrasive zones 102 and the electrically conductive zones 103 are for example distributed randomly (FIG. 2A).

The abrasive zones 102 and the electrically conductive zones can be distributed in a controlled manner (FIGS. 2B to 2E).

According to a variant embodiment, the abrasive zones 102 and the electrically conductive zones are disposed in a controlled manner in order to form an alternation of abrasive zones and non-abrasive zones.

According to another variant embodiment, the conductive zones 103 can be distributed concentrically with respect to the centre of the disc 100 of the grinding wheel (FIG. 2C).

According to another variant embodiment, the conductive zones 103 can be distributed along one or more radii or along one or more diameters (FIG. 2D), randomly or not.

According to another variant embodiment, the conductive zones 103 can be solely disposed on the perimeter of the disc 100 of the grinding wheel (FIG. 2E).

According to another variant embodiment, not shown, the electrically conductive zones 103 are disposed on the edge of the disc 101 of the grinding wheel.

The alternation of abrasive zones 102 and conductive zones 103 can be obtained by means of coatings produced by techniques of depositing thin layers, for example by physical vapour deposition (or PVD), by atomic layer deposition (ALD), by chemical vapour deposition (or CVD), by spin coating or by coating techniques such as for example by dip coating.

The adapted electrical resistance can also be conferred by means of a conductive fabric deposited on the external faces of the cutting tool, thus making it possible to dissociate the mechanical properties (abrasion, controlled hardness given by the abrasive grains contained in the resin) and the electrical properties (adapted resistance, given by the external fabric).

The electrical resistances can also be modulated by means of a cutting fluid and the operating conditions (temperature, viscosity of the fluid, abrasion speed, renewal of the fluid, etc.).

For more safety, the opening system may optionally be associated with a system for controlling the gaseous atmosphere (inert atmosphere or correctly sized extraction system) making it possible to control the oxygen content. Thus the assembly is made safe (with respect to the fire triangle) and allows the simultaneous discharging and opening of cells and accumulators while managing the production of gases caused by opening the cells.

The method can be implemented under inert atmosphere, for example under argon, carbon dioxide, nitrogen or one of the mixtures thereof.

The method can be implemented at temperatures ranging from 5° C. to 80° C., preferably from 20° C. to 60° C., and even more preferentially is implemented at ambient temperature (20-25° C.).

The solution can be cooled to evacuate the calories during the discharge process.

The solution can be stirred to improve the addition of reagent and/or to improve cooling.

The opening method makes it possible to cut the electrochemical generator in complete safety with a view to recycling thereof (by pyrometallurgical or hydrometallurgical method or a combination thereof) or to storage thereof. For example, it may be stored temporarily until it can be transferred, for example to a recycling plant to recover its various components.

Prior to the opening of the electrochemical generator, sorting and dismantling steps may take place. By way of illustration, a recycling method may comprise the following steps:
Sorting,
Pre-dismantling, for example passing from the pack level to the module level in the case of electric vehicle applications,
Opening the electrochemical generator according to the method previously described,
Recycling the materials by conventional methods (pyrometallurgy, hydrometallurgy, etc.) and/or recycling the organic products of the solvent or electrolyte type, preferably by making safe by gentle method, without a temperature rise that degrades the organic product.

The recoverable fractions of the electrochemical generator, in particular the metals constituting the active material, can next be recovered and reused.

### Illustrative and Non-Limitative Example of One Embodiment

In this example, an Li-ion cell is opened with a coppery resinoid grinding wheel in a choline chloride/ethylene glycol medium.

The grinding wheel comprises Al₂O₃ abrasive grains and a discontinuous deposit of Cu on the edge.

The solution in which the cutting is implemented is a mixture of choline chloride and ethylene glycol in a 1:3 molar ratio, furthermore containing an iron electrochemical shuttle for limiting degradation thereof. The viscosity of the mixture is approximately 40 cP. A 18650 Li-ion cell of NMC 811 chemistry, containing a cathode material from among the most reactive, is charged to 100% (3 Ah) and positioned in a tank filled with solution.

The opening action is implemented by means of a resinoid grinding wheel subjected to a rotation speed of 1000 revolutions/min for an exerted pressure of 7.5 N for 2 minutes. The cutting operation is implemented at ambient temperature (20-25° C.) and at atmospheric pressure (1 bar) without recirculation or thermalisation of the cutting fluid (degraded conditions). The resistance of the grinding wheel is greater than 1 kOhm.

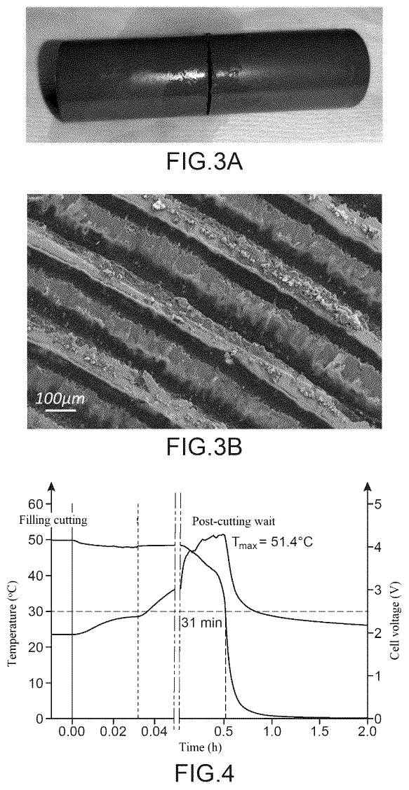

The action of opening by the grinding wheel creates a notch of approximately 1.5 cm² for a thickness of 500 μm (FIGS. 3A and 3B). Observation of the cut under scanning electron microscope shows the absence of crushing and of deformation of the various layers of the cell.

Monitoring the voltage and the temperature during the cut (FIG. 4) shows a significant drop in the voltage during the cutting phase. Discharge then takes place in the discharging fluid. This technique makes it possible not only to open the cell without causing an explosion but also to discharge the cell in less than 35 minutes through the combined action of the adapted resistance of the grinding wheel during opening and of the fluid during the post-opening step. A voltage of 0 V is thus achieved in less than one hour. A voltage drop at cutting and/or post-cutting can be observed.

What is claimed is:

1. A method for opening an electrochemical generator comprising a negative electrode containing lithium or sodium and a positive electrode optionally containing lithium or sodium, the method comprising the following successive steps:
a) immersing the electrochemical generator in a solution comprising an inert liquid and, optionally, a so-called oxidising redox species able to be reduced on the negative electrode so as to discharge the electrochemical generator,
b) opening the electrochemical generator, in the solution, with a cutting element having an electrical resistance of between 1 mΩ and 1 kΩ, and preferably of between 5 mΩ and 100Ω.

2. The method according to claim 1, wherein the inert liquid is deionised water.

3. The method according to claim 1, wherein the inert liquid is an ionic liquid, preferably selected from [BMIM] [TFSI], [P66614] [TFSI], [ETMIm] [TFSI], [DEME] [TFSA], [PYR14] [TFSI], [PP13] [TFSI], [P13] [FSI] and [EMI] [FSI].

4. The method according to claim 1, wherein the inert liquid is a deep eutectic solvent, preferably formed by a choline chloride and a hydrogen bond donor, in particular a glycol or urea.

5. The method according to claim 1, wherein the solution comprises an oxidising redox species and a reducing redox species able to be oxidised on the positive electrode, the oxidising redox species and the reducing redox species forming a redox species pair, the redox species pair preferably being a metal pair, for example selected from Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺, a pair of organic molecules, a pair of metallocenes such as Fc/Fc⁺, or a pair of halogenated molecules such as for example Cl₂/Cl⁻ or Cl⁻/Cl₃⁻.

6. The method according to claim 1, wherein the cutting element comprises a support covered by abrasive zones and electrically conductive zones, the abrasive zones and the electrically conductive zones being disposed randomly or regularly and being associated with the support by a binder.

7. The method according to claim 1, wherein the cutting element is a grinder disc.

8. The method according to claim 1, wherein the cutting element is a cutting wire.

9. The method according to claim 1, wherein step b) is implemented in air or in an inert atmosphere.

10. The method according to claim 1, further comprising, subsequent to step b), a storage step and/or a pyrometallurgical and/or hydrometallurgical step.

11. A cutting element, for opening an electrochemical generator, having an electrical resistance of between 1 mΩ and 1 kΩ, and preferably between 5 mΩ and 100Ω.

12. The cutting element according to claim 11, comprising a support covered by abrasive zones and electrically conductive zones, the abrasive zones and the electrically conductive zones being disposed randomly or regularly and being secured to the support by a binder.

13. The cutting element according to claim 11, wherein the cutting element is a circular saw blade, a saw band, a grinder wheel or a cutting wire.

14. A cutting tool comprising a cutting element according to claim 11, the cutting tool preferably being a grinding machine or a saw, for example a circular saw or a band saw.
